(19) United States
(12) Patent Application Publication
(10) Pub. No.: US 2015/0020609 A1
(43) Pub. Date: Jan. 22, 2015

(54) DETECTION OF LOAD BY SOUND-PROCESSING

(71) Applicant: Caterpillar Inc., Peoria, IL (US)

(72) Inventor: Richard W. Gogolin, Norman Park (AU)

(73) Assignee: Caterpillar Inc., Peoria, IL (US)

(21) Appl. No.: 14/509,097

(22) Filed: Oct. 8, 2014

(51) Int. Cl. G01L 1/00; G01N 29/04

(52) U.S. Cl. CPC G01L 1/00; G01N 29/04
USPC 73/862.59

(57) ABSTRACT

A method for detecting load in a machine, having a loading receptacle, by a load detection system is disclosed. The system includes a sound detection device, a signal-to-data processor with a sound-processing module, a data aggregator, and a data comparator. The method includes recording a continuous rolling audio signal sample corresponding one of an inflow and an outflow event fact. This is monitored for initial indicators. A recorded continuous rolling audio signal sample is recorded for audio pattern recognition. Thereafter, a filtered audio sample is generated. By computing a score for similarity between the filtered audio sample and pre-defined inflow and outflow audio signal templates, a highest scored pattern match is provided. Upon reaching a minimum threshold, the highest scored pattern match is logged. Finally, a data event is outputted based on the highest scored pattern match on at least one of an output port and a user interface.

### TECHNICAL FIELD

The present disclosure relates generally to monitoring a load state in a machine. More specifically, the present disclosure relates to detection of audio signals to monitor the load state in a truck.

### BACKGROUND

Mining environments frequently involve operations of shifting and dumping of a load from one site to another. Such movement often requires the use of mining trucks, such as large mining trucks (LMTs), which facilitate an intake and delivery of the load. Each event of an affiliated load transfer is generally monitored for orchestrating a mine efficiently. Real-time mine orchestration typically includes the record of onsite productivity data. By implication, the number of occasions the mining truck is subject to a load, the time, location, and duration of a load intake and/or outflow, and the like, may be monitored and optimized based on a production plan.

Current methods that monitor an influx and disposal of load from an LMT involve the monitor of the LMT's strut pressure. Such methods are observed to be often inaccurate. This is because the terrains over which the LMTs generally travel and operate include undulations and bumps, which causes the struts to sustain pressure changes frequently. On occasions, affiliated monitoring systems that gauge strut pressure, inadvertently detect a bump and/or an undulation as an influx/disposal of load.

Accelerometers have also been applied to detect an LMT's load state. Given variations in the mine terrain, however, accelerometers may not effectively distinguish between conditions of a load influx/delivery and a deployment or an operation over an inclined terrain.

Inappropriate onsite productivity data may lead to inaccurate real-time fleet management decisions, and consequentially, the quality of productivity data may be imprecise, or at times, contradictory. Such erroneous monitoring may also lead to the over use of LMTs, in turn leading to issues in optimizing LMT application. Continued overuse may cause the LMT to wear out and break down sooner than expected, as well.

U.S. Pat. No. 8,661,902 discloses a method, apparatus, and software, which detects a yield in a mechanical structure by means of an acoustic emission. More particularly, the yield is detected to assess degradation of a component. Although this reference discusses an apparent solution involving the detection of acoustic emissions from a component, no solution suggests a loading activity via acoustic data.

### SUMMARY OF THE INVENTION

Various aspects of the present disclosure illustrate a method for detecting load in a machine by a load detection system. The machine includes a loading receptacle. The load detection system has a sound detection device, a signal-to-data processor that includes a sound-processing module, a data aggregator, and a data comparator. The method includes recording a continuous rolling audio signal sample by the sound detection device. Here, the continuous rolling audio signal sample corresponds to one of an inflow event fact and an outflow event fact. Thereafter, monitoring continuous rolling audio signal sample for initial indicators of the one of inflow event fact and outflow event fact is carried out. A recorded continuous rolling audio signal sample for audio pattern recognition is then duplicated. Next, a filtered audio sample is generated from the continuous rolling audio signal sample by removing noises unrelated to the inflow event fact and outflow events. By computing a score for similarity between the filtered audio sample, and pre-defined inflow audio signal templates and outflow audio signal templates, a highest scored pattern match is provided. The highest scored pattern match is logged upon reaching a minimum threshold. The scored pattern match remains unrecognized if the highest scored pattern match fails to reach the minimum threshold. Finally, a data event is outputted based on the highest scored pattern match on at least one of an output port and a user interface.

### BRIEF DESCRIPTION OF THE DRAWINGS

FIG. 1 is a machine that is subject to a load influx and load outflow, in accordance with the concepts of the present disclosure;

FIG. 2 is a schematic view of a load detection system applied within the machine of FIG. 1, in accordance with the concepts of the present disclosure;

FIG. 3 is a flowchart that depicts overall process steps associated with the load detection system of FIG. 1, in accordance with the concepts of the present disclosure; and

FIG. 4 is a flowchart that depicts a detailed methodology, in accordance with the concepts of the present disclosure.

### DETAILED DESCRIPTION

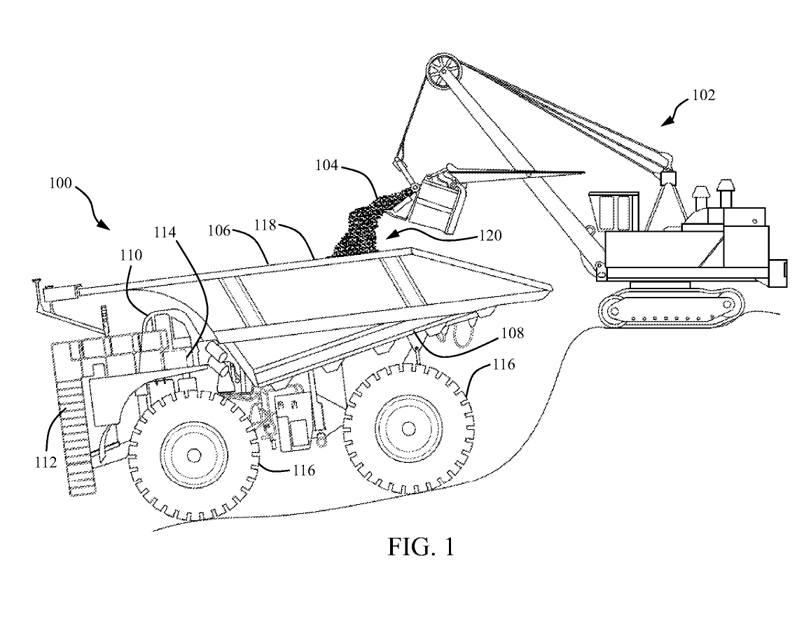

Referring to FIG. 1, there is shown a machine 100 that operates over a rugged terrain, such as a mining field. The machine 100 may be a haul truck, articulated truck, off-highway truck, or a large mining truck (LMT). However, the aspects of the present disclosure may be applied to other mobile machines including, but not limited to, asphalt pavers, scrapers, and the like. Notably, the machine 100 may embody any wheeled or tracked machine associated with mining, agriculture, forestry, construction, and other industrial applications. Moreover, an extension of an application of the present disclosure may be envisioned for similarly configured electrically operated units and stationary machines that receive and deliver load.

Also shown is a loader machine 102 that works in conjunction with the machine 100. More particularly, the loader machine 102 facilitates an influx of a load 104 into the machine 100. The loader machine 102 may be a rope shovel, although other machines, such as backhoe loader, excavator, wheel loader, or other similarly configured machines, may be contemplated. In an embodiment, stationery units, such as conveyor systems, may provide an influx of the load 104, as well. Load 104 may include, but is not limited to, gravel and stones, which possess minerals, ores, and other mineable substances.

The machine 100 includes a loading receptacle 106 supported by a frame 108, an operator cab 110, an engine compartment 112, and a computing unit 114. The frame 108 operably accommodates wheels 116 to operate the machine 100.

The loading receptacle 106 may embody a conventional truck bed. The loading receptacle 106 may include edges 118 formed on the sides of the loading receptacle 106 to define a dump region 120, therein. The dump region 120 may hold the load 104 upon a load influx. The loading receptacle 106 may be manufactured using conventionally known materials. In an embodiment, the material used to fabricate the loading receptacle 106 may include steel and/or other similar materials that generate audio signals upon the influx of the load 104. In some embodiments, the materials used may produce considerably high sound when receiving the load 104. Other materials may be contemplated.

The engine compartment 112 may house an internal combustion engine (not shown), such as a reciprocating piston engine, rotary engine, or a gas turbine engine. In an embodiment, the engine is a spark-ignition engine or a compression ignition engine. Compression ignition engines may include a diesel engine, a homogeneous charge compression ignition engine, or a reactivity controlled compression ignition engine, or other compression ignition engines known in the art. Gasoline, diesel, biodiesel, dimethyl ether, alcohol, natural gas, propane, hydrogen, combinations thereof, or any other combustion fuel known in the art may be applied to power the engine. In an embodiment, the machine 100 is electrically operated.

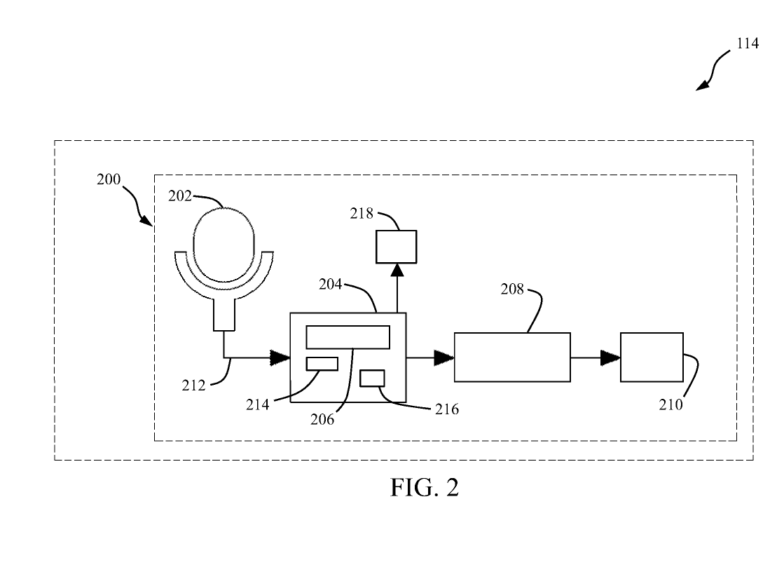

The computing unit 114 may form a processing hub within the machine 100. The computing unit 114 may effectively run a variety of computations and controls related to the machine's function. As an example, a number of implements, such as raising and lowering of the loading receptacle 106, may be controlled via the computing unit 114. In an embodiment, the computing unit 114 may be an independent, standalone unit. Optionally, the computing unit 114 may be connected to the machine's engine control module (ECM), or other surrounding logic devices. Auxiliary applications of the computing unit 114 may include the control of a cabin temperature, blind spot detection, communication related functions, camera controls, and the like. As part of the present disclosure, the computing unit 114 also includes a load detection system 200 (see FIG. 2).

Referring to FIG. 2, there is shown the load detection system 200, housed within the computing unit 114. The load detection system 200 includes a sound detection device 202, a signal-to-data processor 204, a sound-processing module 206 configured within the signal-to-data processor 204, a data aggregator 208, a data comparator 210. A user interface 218 may be configured as part of the load detection system 200. However, connections to user interfaces from other applications within the machine 100 may be applied as well.

The sound detection device 202 may embody a microphone. For ease in accessibility and service, the sound detection device 202 may be housed within the operator cab 110 (see FIG. 1). The sound detection device 202 may also be situated at a location remote from the signal-to-data processor 204 and the operator cab 110 (see FIG. 1). As an example, the sound detection device 202 may be positioned relatively close to the source of the sound that requires to be captured. Accordingly, the sound detection device 202 may be located beneath and/or beside the loading receptacle 106, to adequately receive an audio signal upon an influx and/or outflow of the load 104 (see FIG. 1). More particularly, the audio signal may be a continuous rolling audio signal sample. In an embodiment, multiple sound detection devices 202 may be positioned in diverse location of the machine 100. Further, the sound detection device 202 may detect one or more audio signals upon a load influx. The sound detection device 202 may also detect audio signals related to an outflow of the load 104 (see FIG. 1). Further, the sound detection device 202 may be operably connected to the signal-to-data processor 204 via a cabled link 212. A connection between the sound detection device 202 and the signal-to-data processor 204 may be wirelessly configured.

The signal-to-data processor 204 may be a microprocessor-based device that receives audio signals from the sound detection device 202. Subsequent to the delivery of the audio signals, the signal-to-data processor 204 may process and convert those signals to a format readable by the sound-processing module 206 and the data aggregator 208. Such a format may be further compatible for a delivery to the data comparator 210, enabling operator/users to visually inspect and read the processed signal. Moreover, the readable format may be useable for the user interface 218 to allow users to view and receive the data. Connections and delivery of such processed signals to a remote location may be contemplated. Options may be further contemplated to include a series of processors, all set to carry out functions related to the disclosed system, sequentially.

The sound-processing module 206 may include a sound-processing software installed within one of the non-volatile memory units of the signal-to-data processor 204. The sound-processing software may receive the continuous rolling audio signal sample. The sound-processing software may facilitate detection of a change in the state of load 104 from the loading receptacle 106 based on certain predefined functional factors. As an example, audio signals from the influx of the load 104 may differ from those produced by the machine's engine, processes/operations running in the vicinity, and/or from other surrounding environmental sounds. Another factor of influx determination may be based upon the material of the load 104 (see FIG. 1). For example, a delivery of load 104 containing gravel, stones, and /or other materials, into an empty loading receptacle 106, may produce a specific sound, distinguishable from the sounds of other activity, objects, or events. The load 104 (see FIG. 1) may also include finer and softer materials that differ from heavy gravel and hard stones. Multiple audio signals, therefore, may be captured upon a load influx.

Accordingly, the sound-processing module 206 may process the recorded continuous rolling audio signal sample, while also differentiating from sounds that arise from other activities. In that manner, the sound-processing module 206 may suitably detect when a load influx has occurred, irrespective of the surrounding sounds or what constitutes the load 104 (see FIG. 1). For processing the continuous rolling audio signal sample, audio files of an influx of gravel, stones, and other materials, may be stored in the memory of the signal-to-data processor 204, or other processers of the load detection system 200. This may facilitate audio pattern recognition. Such audio files may be compared with the continuous rolling audio signal sample to determine an influx (or an outflow) of load 104. Effectively, the sound-processing module 206 may process the continuous rolling audio signal sample from ambient sound signals to generate a filtered audio sample. In that way, the sound-processing module 206 may determine a load influx or a load outflow. The memory may also store a minimum decibel threshold associated with each of these materials. Moreover, inflow and outflow audio signal templates may be stored as well.

In an embodiment, influx (or outflow) audio signals may be amplified by an amplifier (not shown) configured within the sound-processing module 206. The amplifier may further assist in identifying and distinguishing the related activity (one of an influx or an outflow event fact).

Additionally, the sound-processing module 206 may include a sound filter 214 for cleaning the signals and removing ambient noise indicative of a particular activity. This may occur before the sound-processing module 206 processes the continuous rolling audio signal sample. The sound filter 214 generally helps to further differentiate between the sound signals of the distinct activities of an influx (or outflow). As already noted, such sound signals may include sounds produced from the engine and the environment, which are different from the sound of an influx or an outflow of load 104.

The sound filter 214 may be at least one of a low pass filter or a high pass filter that captures a substantially distinct audio signal of the influx (or outflow). In so doing, the sound filter 214 cleans-up incoming audio signals considerably, thereby assisting in further processing. Otherwise, the sound-processing module 206 may be required to differentiate between multiple unfiltered audio signals, thus increasing the possibility of errors.

The continuous rolling audio signal sample may emit a relatively steady audio signal for a period. For example, a set, predefined period. However, strength of audio signals may also change during an influx (or outflow) procedure. For example, an audio signal emitted at the beginning of an influx may differ from the audio signal emitted during the influx and the audio signal emitted at the end of the influx. Such an instance may require the storage of corresponding data or audio files with which the emitted audio signals may be compared to for suitably capturing varying sound of an influx. Such techniques and related sensing capabilities may help determine, for example, when a load influx into the loading receptacle 106 has begun, and when the influx has ended. Additionally, the time at which an influx began and a time at which the influx ended may be recorded as well. Similar techniques may be used to identify an outflow of the load 104 (see FIG. 1).

A timer 216 may be set, or optionally connected, to the signal-to-data processor 204. The timer 216 may impart tracking functionality to the load detection system 200. For example, the timer 216 may note each new load being added to the loading receptacle 106 (see FIG. 1). Additionally, based on a recorded continuous rolling audio signal sample, the timer 216 may also note when the machine 100 has been relieved of a dumped load. A corresponding timer data may be recorded and stored in the memory for later retrieval, reporting, and tracking, by the signal-to-data processor 204. After performing a tracking operation, the timer 216 may deliver a timing data that corresponds to the load influx to the data aggregator 208, which may be serially connected with the timer 216. Functionality of the timer 216 may include in any one of the processors described above. The timer 216 may operate similarly for a load outflow.

The data aggregator 208 may log information upon receipt of an associated input. Input may include the filtered audio sample from the sound-processing module 206, associated with the detection of a load influx (or outflow). Segregation modules (not shown) set within the data aggregator 208, may sequentially classify each influx occurrence. Apart from logging each influx occurrence, the data aggregator 208 may also log data that corresponds to the start and stop of each influx operation. Similarly, each occurrence that corresponds to a load delivery may also be classified.

The data comparator 210 may also be serially connected with the data aggregator 208. The data comparator 210 may include entities or processors, such as the signal-to-data processor 204, which recognize sequential occurrences of logical data received from the data aggregator 208. More particularly, the data comparator 210 may match the difference between the filtered audio samples of the influx and outflow, generated by the sound-processing module 206. Consequently, a difference may be indicated between the filtered audio samples of the influx and outflow. This difference may be representative of the time elapsed between the influx of load 104 and outflow of load 104. Effectively, the data comparator 210 generates the difference between the filtered influx signal and the filtered outflow signal as a function of time.

In an embodiment, the data comparator 210 may tally the time elapsed between the start of an influx and the end of an influx. Likewise, time duration between the start of a load outflow and an end of the load outflow may also be tallied and generated. These operations may require the data comparator 210 to include a processor, similar to the signal-to-data processor 204 that may compute the related time data. A generated data may be displayed or outputted as a feedback to one or more operators, stationed at a user interface 218. The feedback may be generated as a tabulated set. Options may also include remote retrieval of a resultant compared data.

Generally, each type of processer disclosed in the application may include a set of volatile/non-volatile memory units, such as random access memory (RAM) and/or read-only memory (ROM), and associated input and output buses. For example, the memory units may store information of a detected audio signal during the influx and after the influx. Moreover, the processors may be envisioned as an application-specific, integrated circuit, which complies with one or more known logic devices. Optionally, the processors may extend to provide controller functionality to certain surrounding applications. In an embodiment, the processors may form a portion of the computing unit 114, or may alternatively be a standalone entity.

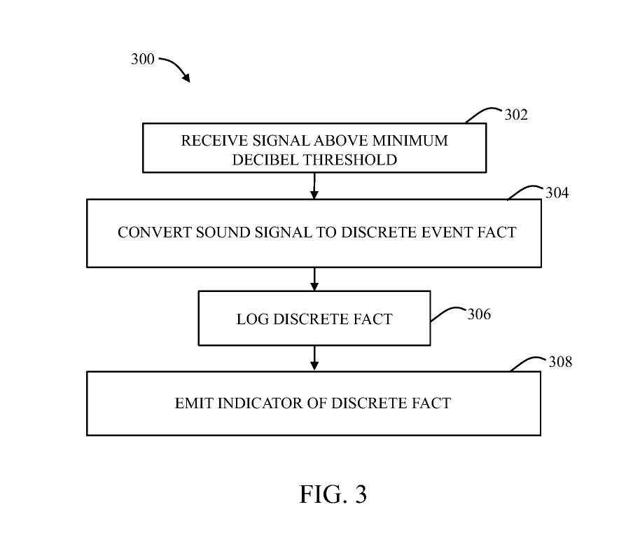

Referring to FIG. 3, a method in connection with the load detection system 200 applied within the machine 100 (see FIG. 1) is shown. The method is depicted by way of a flowchart 300. Notably, the flowchart 300 includes a basic flow of operations of the load detection system 200. For ease in reference, an audio signal may be interchangeably referred to as a sound signal.

The method initiates at step 302. At step 302, the sound signal is generated by material hitting the loading receptacle 106. The sound detection device 202 receives that energy and generates a sound signal (which may be an electrical signal). Notably, the sound detection device 202 receives the corresponding signal above a minimum decibel threshold. The method proceeds to step 304.

At step 304, the signal-to-data processor 204 converts the sound signal to a discrete event fact. The method proceeds to step 306.

At step 306, the data aggregator 208 receives and logs the discrete event fact. The method proceeds to step 308.

At step 308, the data comparator 210 emits indication of the discrete event fact through one of an output port and/or user interface 218. In the absence of an integral user interface, the load detection system 200 may integrate with other systems or sub-systems, which may have a user interface.

### INDUSTRIAL APPLICABILITY

In the context of fleet management, monitoring of a real-time state of the fleet includes optimizing LMT (machine 100) utilization across the mining site. A historical record of a state of the machine 100 may be applied as a basis for productivity data. As an example, a historical record may include data corresponding the number of load operation (or transfer), the location of load intake/outflow, and the duration of an intake/outflow. End users or customers may further establish a variety of the operational parameters based on these factors. For example, monitoring a target for the number of load transfers, keeping an account of transferred (or extracted) ore and mined materials, operator performance management (identifying operators that take a longer time to load), and the like.

In operation, an operator deployed within the operator cab 110 may activate the load detection system 200. From a load-receiving site, the machine 100 (see FIG. 1) may repeatedly travel to and from a dumpsite where the load 104 (see FIG. 1) may be delivered. Such an operation may require to be monitored for the machine's workability and staffing requirements. Regular monitoring may help in optimizing machine (100) operations. Notably, an outflow event occurs when the machine 100 has received the load 104 and is poised to deliver the load 104 to a dumpsite.

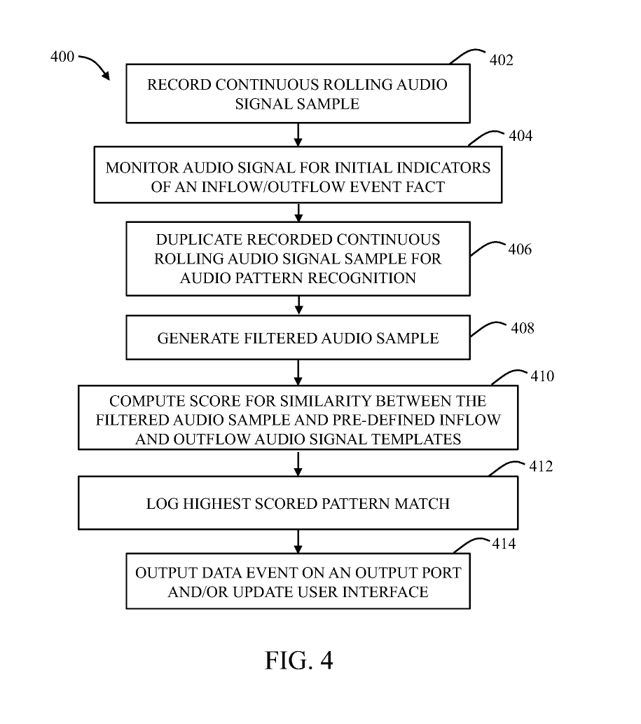

Referring to FIG. 4, a flowchart 400, which depicts a stage wise and detailed method for detecting load in the machine 100, as applied in a mining environment, is shown. Load detection is carried out by the load detection system 200 (see FIG. 2). The method is discussed in connection with the system described in FIGS. 1 and 2. The method initiates at step 402.

At step 402, the sound detection device 202 detects and records a continuous rolling audio signal sample. The method proceeds to step 404.

At step 404, the load detection system 200 monitors the audio signal for initial indicators of an inflow or outflow event fact such as noise of a high magnitude (decibel) and/or low frequency. For example, monitoring may be performed as the audio signal exceeds a minimum decibel threshold. The method proceeds to step 406.

At step 406, the sound-processing software in the sound-processing module 206 differentiates and/or duplicates, recorded continuous rolling audio signal sample for audio pattern recognition. The audio pattern recognition may be compared between multiple sound signals received from the recorded audio signal corresponding one of the influx of outflow of load 104. The method proceeds to step 408.

At step 408, the load detection system 200 deactivates audio signal recording, while the sound-processing software generates a filtered audio sample removing noises unrelated with the inflow or outflow events. The method proceeds to step 410.

At step 410, the sound-processing software in the sound-processing module 206 processes and computes a score for similarity between the filtered audio sample and pre-defined inflow and outflow audio signal templates. The method proceeds to step 412.

At step 412, the data aggregator 208 logs the highest scored pattern match upon reaching a minimum threshold (which may be a minimum decibel threshold). Conversely, a scored pattern match may remain unrecognized if the highest score does not reach the minimum threshold. This includes logging the data event and time. The method proceeds to end step 414.

At end step 414, the data comparator 210 outputs data event on an output port and/or update the user interface 218. A data signal is outputted indicative of either an influx of load 104, or outflow of load 104, or an unrecognized sound. The load detection system 200 outputs a digital data signal (not sound) indicating that at least one of an inflow or an outflow was detected. The timer 216 (or a system clock) configured within the load detection system 200 may track when that real-life event occurred.

Load detection system 200 may be applied for fleet management systems that monitor machine states via wireless network. Real-time tracking allows the management system to optimize site-wide efficiency (moving the most ore, increasing machine utilization, reducing tire wear, reducing fuel usage). Such fleet management systems may also retain a history of machine states to maintain a record of production and performance. Such parameters may include the number of loading performed, location of loading, the time of load, and duration for loads. A computable average loading time may serve as an indicator of operator performance.

Further, logs may be generated and maintained on everyday basis, and machine utilization may be tracked. For example, the number of trips the machine 100 has made may be determined and machine efficiency may be calculated. In this manner, the machine 100 may be kept from overuse. Moreover, implementation of the sound detection system may cover aspects where the load detection system 200 may be applied as a removable kit so that a varied set of machines may benefit from the aspects of the present disclosure.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method for detecting load in a machine by a load detection system, the machine including a loading receptacle, the load detection system including a sound detection device, a signal-to-data processor that includes a sound-processing module, a data aggregator, a data comparator, the method comprising:
recording a continuous rolling audio signal sample by the sound detection device, the continuous rolling audio signal sample corresponding one of:
an inflow event fact; and
an outflow event fact;
monitoring continuous rolling audio signal sample for initial indicators of one of the inflow event fact and the outflow event fact;
duplicating a recorded continuous rolling audio signal sample for audio pattern recognition;
generating a filtered audio sample from the continuous rolling audio signal sample by removing noises unrelated to the inflow event fact and the outflow event fact;
computing a score for similarity between the filtered audio sample and pre-defined inflow audio signal templates and outflow audio signal templates, thereby providing a highest scored pattern match;
logging the highest scored pattern match upon reaching a minimum threshold, wherein a scored pattern match remains unrecognized if the highest scored pattern match fails to reach the minimum threshold;
outputting a data event based on the highest scored pattern match on at least one of an output port and a user interface.
